(19) United States
(12) Patent Application Publication
(10) Pub. No.: US 2026/0302154 A1
(43) Pub. Date: Oct. 1, 2026

(54) LIGHT-EMITTING SEALED BODY

(71) Applicant: HAMAMATSU PHOTONICS K.K., Hamamatsu-shi, Shizuoka (JP)

(72) Inventors: Akio SUZUKI, Hamamatsu-shi, Shizuoka (JP); Masaru SHIMOMAKI, Hamamatsu-shi, Shizuoka (JP); Yu MATSUSHIRO, Hamamatsu-shi, Shizuoka (JP); Kohei SUGITANI, Hamamatsu-shi, Shizuoka (JP)

(73) Assignee: HAMAMATSU PHOTONICS K.K., Hamamatsu-shi, Shizuoka (JP)

(21) Appl. No.: 19/477,615

(22) PCT Filed: Dec. 21, 2023
(86) PCT No.: PCT/JP2023/046001

§ 371 Date: Oct. 22, 2025

(30) Foreign Application Priority Data
Apr. 27, 2023 (JP) 2023-073565

(51) Int. Cl. H01J 65/04; H01J 61/30; H01J 61/34

(52) U.S. Cl. CPC H01J 65/04; H01J 61/305; H01J 61/34; H01J 2893/0008; H01J 2893/0009; H01J 2893/0063

(57) ABSTRACT

A light-emitting sealed body includes a housing including a first window configured to cause first light for maintaining the plasma to be incident on the plasma region and a second window configured to cause second light emitted from the plasma to be emitted from the plasma region, a first electrode having a first distal end facing the plasma region, a second electrode having a second distal end facing the plasma region, the second distal end facing the first distal end with the plasma region interposed therebetween, an insulating first holder holding the first electrode and fixed to the housing, and an insulating enclosure enclosing the plasma region, the first distal end, and the second distal end and having a first opening corresponding to the first window and a second opening corresponding to the second window. At least a part of the enclosure is provided to the first holder.

### TECHNICAL FIELD

The present disclosure relates to a light-emitting sealed body applied to, for example, a laser excitation light source.

### BACKGROUND ART

As a light-emitting sealed body applied to a laser excitation light source, there is known a light-emitting sealed body including a housing that houses a gas for generating plasma, an enclosure that defines an enclosed space including a plasma region in the housing, and a pair of electrodes having a pair of distal ends facing each other in the enclosed space. The housing includes a laser beam incidence window for causing a laser beam for maintaining the plasma to be incident on the plasma region and a plasma light emission window for emitting plasma light emitted from the plasma from the plasma region (see, for example, Patent Literature 1). In such a light-emitting sealed body, a voltage is applied between the pair of electrodes, and thus, arc discharge occurs in the gas in the enclosed space. As a result, the plasma is generated in the enclosed space.

### CITATION LIST

### Patent Literature

Patent Literature 1: Specification of U.S. Pat. No. 10,008,378

### SUMMARY OF INVENTION

### Technical Problem

In the light-emitting sealed body described above, since a space where the gas convects is narrowed as compared with a case where the enclosure is not disposed in the housing, the convection in the gas is less likely to occur in the space. When the convection in the gas becomes strong, since an adverse effect such as a noise component being added to the plasma light emitted to an outside of the housing occurs, the convection in the gas is suppressed, and thus, deterioration in quality of output light is suppressed. However, when the light-emitting sealed body vibrates for some reason, the vibration is transmitted to the enclosure, and the enclosure vibrates, there is a concern that the quality of the output light deteriorates due to the vibration.

An object of the present disclosure is to provide a light-emitting sealed body capable of improving quality of output light.

### Solution to Problem

A light-emitting sealed body according to one aspect of the present disclosure is [1] “a light-emitting sealed body including a housing that houses a gas for generating plasma, the housing including a first window configured to cause first light for maintaining the plasma in a plasma region where the plasma is generated to be incident on the plasma region and a second window configured to emit second light emitted from the plasma from the plasma region, a first electrode having a first distal end facing the plasma region in the housing, a second electrode having a second distal end facing the plasma region in the housing, the second distal end facing the first distal end with the plasma region interposed therebetween, an insulating first holder holding the first electrode and fixed to the housing, and an insulating enclosure enclosing the plasma region, the first distal end, and the second distal end in the housing and having a first opening corresponding to the first window and a second opening corresponding to the second window, in which at least a part of the enclosure is provided to the first holder”.

In the light-emitting sealed body according to the above [1], the plasma region, the first distal end of the first electrode, and the second distal end of the second electrode are enclosed by the insulating enclosure in the housing. As a result, since the space where the gas convects is narrowed as compared with a case where the enclosure is not disposed in the housing, it is possible to suppress the occurrence of the convection in the gas in the space. In addition, at least a part of the enclosure is provided to the first holder that fixes the first electrode to the housing. That is, since the first holder for fixing the first electrode to the housing also serves as at least a part of the enclosure, at least a part of the enclosure is reliably fixed to the housing, and the vibration in the enclosure can be suppressed. Thus, according to the light-emitting sealed body according to the above [1], it is possible to improve the quality of the output light.

The light-emitting sealed body according to one aspect of the present disclosure may be [2] “the light-emitting sealed body according to the above [1], further including an insulating second holder holding the second electrode and fixed to the housing, in which the enclosure has a first enclosing portion and a second enclosing portion, the first enclosing portion is provided as the part to the first holder, and the second enclosing portion is provided in the second holder”. In accordance with the light-emitting sealed body according to the above [2], it is possible to accurately form the enclosure having a preferable shape for suppressing the occurrence of the convection, and to stably support the enclosure by the two holders.

The light-emitting sealed body according to one aspect of the present disclosure may be [3] “the light-emitting sealed body according to the above [1], in which the entire enclosure is provided to the first holder”. In accordance with the light-emitting sealed body according to the above [3], it is possible to stably support the enclosure with a simple structure.

The light-emitting sealed body according to one aspect of the present disclosure may be [4] “the light-emitting sealed body according to any one of the above [1] to [3], in which the housing has a housing space in which the enclosure is disposed, and a third opening opened to one side in a predetermined direction from the housing space, the first holder extends along the predetermined direction inside the third opening, a groove extending along the predetermined direction is formed on one of an inner surface of the third opening and an outer surface of the first holder, and a protrusion extending along the predetermined direction and disposed in the groove is provided to the other of the inner surface of the third opening and the outer surface of the first holder”. In accordance with the light-emitting sealed body according to the above [4], at the time of manufacturing the light-emitting sealed body, the enclosure is disposed in the housing space of the housing and the first holder is disposed inside the third opening of the housing via the third opening of the housing. Thus, the first opening of the enclosure can correspond to the first window of the housing, and the second opening of the enclosure can correspond to the second window of the housing. In addition, in the manufactured light-emitting sealed body, it is possible to reliably maintain a state where the first opening of the enclosure corresponds to the first window of the housing and the second opening of the enclosure corresponds to the second window of the housing.

The light-emitting sealed body according to one aspect of the present disclosure may be [5] “the light-emitting sealed body according to any one of the above [1] to [4], further including a conductive sealing tube configured to perform at least one of discharge of the gas from the housing and introduction of the gas into the housing, in which a part of the first electrode and a part of the sealing tube are electrically connected to each other in a state of being embedded in the first holder”. In accordance with the light-emitting sealed body according to the above [5], not only the sealing tube can be used to perform at least one of the discharge of the gas from the housing and the introduction of the gas into the housing, but also the sealing tube can be used to electrically connect the first electrode to the external wiring. Thus, for example, the light-emitting sealed body can be made compact as compared with a case where the sealing tube is provided in the housing separately from the first holder.

The light-emitting sealed body according to one aspect of the present disclosure may be [6] “the light-emitting sealed body according to any one of the above [1] to [5], in which the enclosure defines an enclosed space including the plasma region in the housing, the first window is positioned on an opposite side to the enclosed space with respect to an open end of the first opening on the enclosed space side, the second window is positioned on an opposite side to the enclosed space with respect to an open end of the second opening on the enclosed space side, and at least one of the first opening and the second opening is narrowed with respect to the enclosed space”. In accordance with the light-emitting sealed body according to the above [6], since the gas in the enclosed space is less likely to be influenced by the environment outside the housing as compared with a case where both the first opening and the second opening are not narrowed with respect to the enclosed space, it is possible to suppress the occurrence of the convection in the gas due to the environment outside the housing.

### Advantageous Effects of Invention

In accordance with the present disclosure, it is possible to provide the light-emitting sealed body capable of improving the quality of the output light.

### BRIEF DESCRIPTION OF DRAWINGS

FIG. 1 is a sectional view of a light-emitting sealed body of a first embodiment.

FIG. 2 is a sectional view of the light-emitting sealed body taken along line II-II illustrated in FIG. 1.

FIG. 3 is a sectional view of the light-emitting sealed body taken along line III-III illustrated in FIG. 1.

FIG. 4 is a sectional view of a light-emitting sealed body of a second embodiment.

FIG. 5 is a sectional view of a light-emitting sealed body of a third embodiment.

FIG. 6 is a sectional view of the light-emitting sealed body taken along line VI-VI illustrated in FIG. 5.

FIG. 7 is a sectional view of the light-emitting sealed body taken along line VII-VII illustrated in FIG. 5.

FIG. 8 is a sectional view of a light-emitting sealed body of a fourth embodiment.

FIG. 9 is a sectional view of the light-emitting sealed body taken along line IX-IX illustrated in FIG. 8.

FIG. 10 is a sectional view of the light-emitting sealed body taken along line X-X illustrated in FIG. 8.

FIG. 11 is a sectional view of a light-emitting sealed body of a fifth embodiment.

FIG. 12 is a sectional view of the light-emitting sealed body taken along line XII-XII illustrated in FIG. 11.

FIG. 13 is a sectional view of the light-emitting sealed body taken along line XIII-XIII illustrated in FIG. 11.

### DESCRIPTION OF EMBODIMENTS

Hereinafter, embodiments of the present disclosure will be described in detail with reference to the drawings. Note that, in the drawings, the same or corresponding parts are denoted by the same reference signs, and redundant description will be omitted.

### First Embodiment

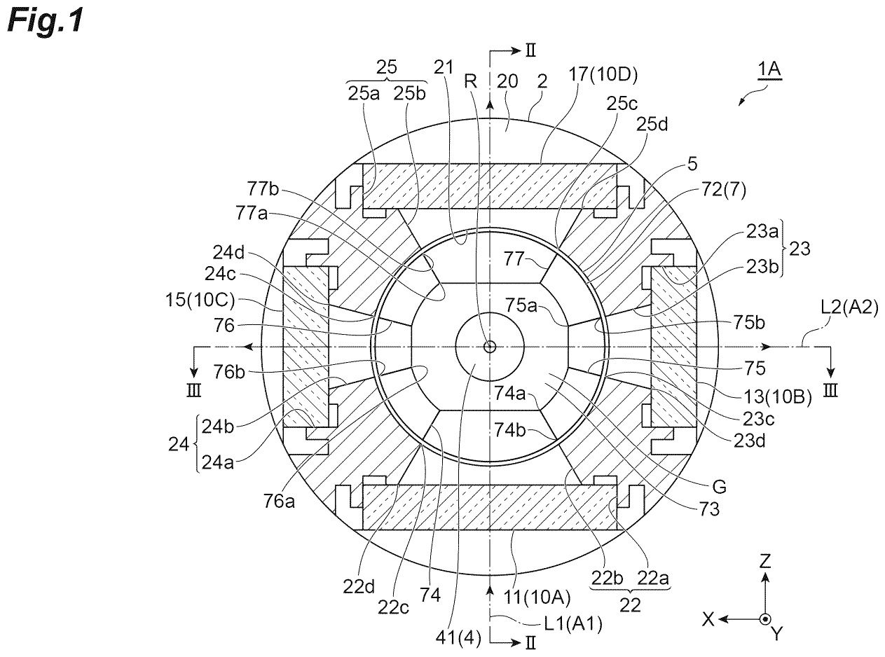

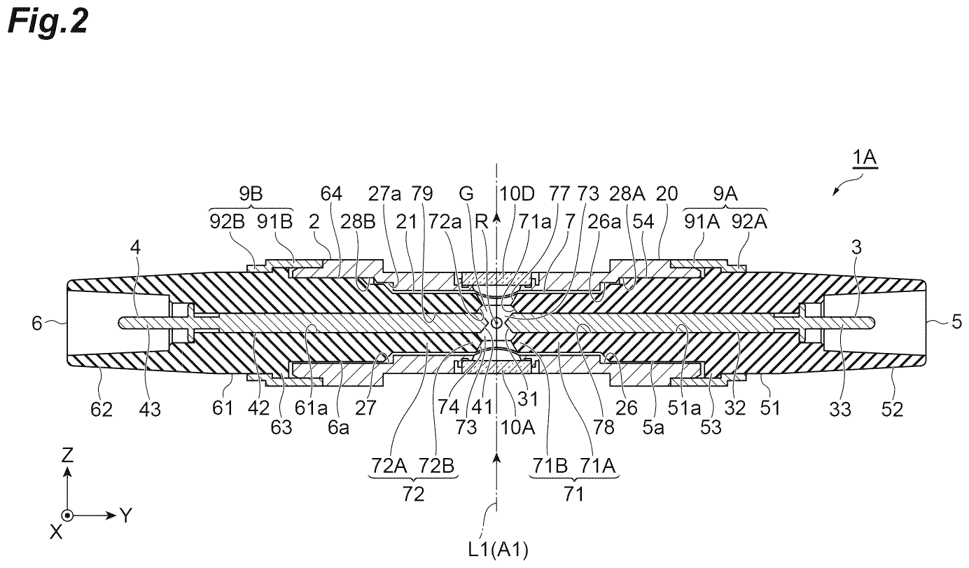

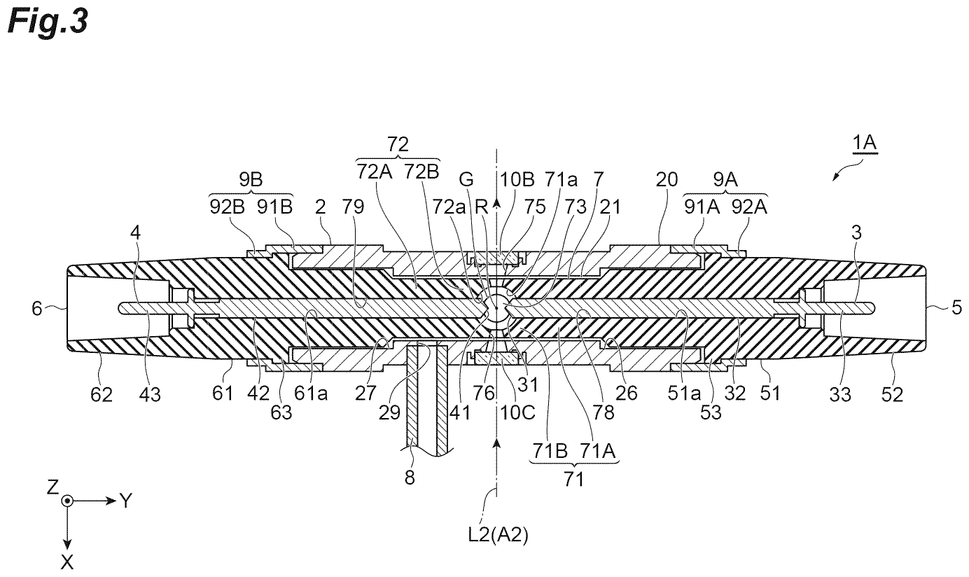

As illustrated in FIGS. 1, 2, and 3, a light-emitting sealed body 1A of a first embodiment includes a housing 2, a first electrode 3, a second electrode 4, a first holder 5, a second holder 6, an enclosure 7, and an encapsulation tube 8. The housing 2 houses a gas G for generating plasma. The gas G is, for example, xenon gas. In the light-emitting sealed body 1A, a laser beam (first light) L1 for maintaining plasma is incident on a plasma region R (region where plasma is generated in the gas G), and plasma light (second light) L2 emitted from the plasma is emitted from the plasma region R. Note that, although the plasma light L2 emitted from the plasma is actually radiationally generated in all directions around the plasma region R, only the plasma light L2 as output light is illustrated for the sake of convenience. A wavelength of the laser beam L1 is, for example, about 800 nm to 1100 nm, and a wavelength of the plasma light L2 is, for example, about 120 nm to 20 μm. The light-emitting sealed body 1A is a device applied to a laser excitation light source.

The housing 2 includes a main body 20, a laser beam incidence window (first window) 10A, two plasma light emission windows (second windows) 10B and 10C, and a laser beam emission window 10D. The main body 20 is a substantially tubular member extending along a Y-axis direction. In the main body 20, a housing space 21, four window openings 22, 23, 24, and 25, and two electrode openings (third openings) 26 and 27 are formed. The housing space 21 is positioned near a center of the main body 20 along the Y-axis direction and includes the plasma region R. A material of the main body 20 is, for example, metal such as stainless steel.

The window opening 22 is opened to one side in a Z-axis direction (a direction perpendicular to the Y-axis direction) from the housing space 21. The window opening 22 includes two openings 22a and 22b. The opening 22a is an opening positioned on one side in the Z-axis direction with respect to the opening 22b. A space inside the opening 22a has a substantially cylindrical shape. The opening 22b is a tapered opening in which an open end 22c on the housing space 21 side is smaller than an open end 22d on an opposite side to the housing space 21. The open end 22d is positioned on a bottom surface of the opening 22a. The window opening 25 is opened to the other side in the Z-axis direction from the housing space 21. The window opening 25 includes two openings 25a and 25b. The opening 25a is an opening positioned on one side in the Z-axis direction with respect to the opening 25b. A space inside the opening 25a has a substantially cylindrical shape. The opening 25b is a tapered opening in which an open end 25c on the housing space 21 side is smaller than an open end 25d on an opposite side to the housing space 21. The open end 25d is positioned on a bottom surface of the opening 25a.

The window opening 23 is opened to one side in an X-axis direction (a direction perpendicular to both the Y-axis direction and the Z-axis direction) from the housing space 21. The window opening 23 includes two openings 23a and 23b. The opening 23a is an opening positioned on one side in the X-axis direction with respect to the opening 23b. A space inside the opening 23a has a substantially cylindrical shape. The opening 23b is a tapered opening in which an open end 23c on the housing space 21 side is smaller than an open end 23d on an opposite side to the housing space 21. The open end 23d is positioned on a bottom surface of the opening 23a. The window opening 24 is opened to the other side in the X-axis direction from the housing space 21. The window opening 24 includes two openings 24a and 24b. The opening 24a is an opening positioned on one side in the X-axis direction with respect to the opening 24b. A space inside the opening 24a has a substantially cylindrical shape. The opening 24b is a tapered opening in which an open end 24c on the housing space 21 side is smaller than an open end 24d on an opposite side to the housing space 21. The open end 24d is positioned on a bottom surface of the opening 24a.

The electrode opening 26 is opened to one side in the Y-axis direction from the housing space 21. A groove 28A extending along the Y-axis direction is formed in an inner surface 26a of the electrode opening 26. The groove 28A is recessed to an opposite side to the first holder 5 along the Z-axis direction. The groove 28A is opened to an outside of the housing 2 along the Y-axis direction. The electrode opening 27 is opened to the other side in the Y-axis direction from the housing space 21. A groove 28B extending along the Y-axis direction is formed in an inner surface 27a of the electrode opening 27. The groove 28B is recessed to an opposite side to the second holder 6 along the Z-axis direction. The groove 28B is opened to the outside of the housing 2 along the Y-axis direction.

The laser beam incidence window 10A airtightly seals the window opening 22. The laser beam incidence window 10A is positioned in the opening 22a and covers the entire opening 22b. The laser beam incidence window 10A causes the laser beam L1 to be incident on the plasma region R. In the light-emitting sealed body 1A, the laser beam incidence window 10A causes the laser beam L1 to be incident on the plasma region R along an optical axis A1 parallel to the Z-axis direction. In other words, an optical axis of the laser beam L1 is A1.

The laser beam incidence window 10A includes a window member 11. The window member 11 is formed in a plate shape with the optical axis A1 as a center line and the Z-axis direction as a thickness direction. The window member 11 transmits the laser beam L1. A material of the window member 11 is a light transmissive material having a light transmission property at least for a wavelength of the laser beam L1, and is, for example, sapphire. A side surface of the window member 11 is airtightly joined to an inner surface of the opening 22a by a joining material such as a metal brazing material.

The plasma light emission window 10B airtightly seals the window opening 23. The plasma light emission window 10B is positioned in the opening 23a and covers the entire opening 23b. The plasma light emission window 10B emits the plasma light L2 to one side in the X-axis direction from the plasma region R. The plasma light emission window 10C airtightly seals the window opening 24. The plasma light emission window 10C is positioned in the opening 24a and covers the entire opening 24b. The plasma light emission window 10C emits the plasma light L2 to the other side in the X-axis direction from the plasma region R. In the light-emitting sealed body 1A, each of the plasma light emission windows 10B and 10C emits the plasma light L2 from the plasma region R along an optical axis A2 parallel to the X-axis direction. In other words, an optical axis of the plasma light L2 is A2. Note that, the optical axis A1 and the optical axis A2 intersect at a center of the plasma region R, and intersect vertically in the present embodiment.

The plasma light emission window 10B has a window member 13. The window member 13 is formed in a plate shape with the optical axis A2 as a center line and the X-axis direction as a thickness direction. The window member 13 transmits the plasma light L2. A material of the window member 13 is a light transmissive material having a light transmission property at least for the wavelength of the plasma light L2, and is, for example, diamond, sapphire, or magnesium fluoride. A side surface of the window member 13 is airtightly joined to an inner surface of the opening 23a by a joining material such as a metal brazing material.

The plasma light emission window 10C has a window member 15. The window member 15 is formed in a plate shape with the optical axis A2 as a center line and the X-axis direction as a thickness direction. The window member 15 transmits the plasma light L2. A material of the window member 15 is a light transmissive material having a light transmission property at least for the wavelength of the plasma light L2, and is, for example, diamond, sapphire, or magnesium fluoride. A side surface of the window member 15 is airtightly joined to an inner surface of the opening 24a by a joining material such as a metal brazing material.

The laser beam emission window 10D airtightly seals the window opening 25. The laser beam emission window 10D is positioned in the opening 25a and covers the entire opening 25b. The laser beam emission window 10D emits the laser beam L1 transmitted through the plasma region R from the plasma region R. In the present embodiment, in addition to the laser beam L1 transmitted through the plasma, the plasma light L2 emitted from the plasma region R to the laser beam emission window 10D side is also emitted, but is not illustrated for simplification of the drawing. Note that, an optical axis of the plasma light L2 emitted from the laser beam emission window 10D is coaxial with the laser beam L1. In the light-emitting sealed body 1A, the laser beam emission window 10D emits the laser beam L1 from the plasma region R along the optical axis A1. In other words, the emitted light emitted from the laser beam emission window 10D has an optical axis coaxial with the optical axis A1 of the laser beam L1.

The laser beam emission window 10D includes a window member 17. The window member 17 is formed in a plate shape with the optical axis A1 as a center line and the Z-axis direction as a thickness direction. The window member 17 transmits the laser beam L1. A material of the window member 17 is a light transmissive material having a light transmission property at least for the wavelength of the laser beam L1, and more preferably a light transmissive material having a light transmission property for the wavelength of the plasma light L2 in addition to the wavelength of the laser beam L1. In the present embodiment, the material of the window member 17 is a material having a light transmission property for the wavelengths of both the laser beam L1 and the plasma light L2, and is, for example, sapphire. A side surface of the window member 17 is airtightly joined to an inner surface of the opening 25a by a joining material such as a metal brazing material.

The first electrode 3 extends from the outside of the housing 2 into an enclosed space 73 defined by the enclosure 7 via the electrode opening 26 of the housing 2 and an electrode opening 78 of the enclosure 7 to be described later. In the light-emitting sealed body 1A, the first electrode 3 is a rod-shaped member extending in the Y-axis direction. A material of the first electrode 3 is, for example, a metal material having a high melting point such as tungsten. A distal end (first distal end) 31 of the first electrode 3 faces the plasma region R in the housing 2. In the light-emitting sealed body 1A, the distal end 31 of the first electrode 3 faces the plasma region R in the enclosed space 73 and is enclosed by the enclosure 7.

The first holder 5 is an insulating member extending along the Y-axis direction, and holds the first electrode 3. A material of the first holder 5 is an insulating material having high temperature resistance, and is, for example, ceramic. The first holder 5 includes a main body 51 and a tubular portion 52. A part of the main body 51 is positioned inside the housing 2, and the rest of the main body 51 is positioned outside the housing 2. The tubular portion 52 is provided on a portion of the main body 51 positioned outside the housing 2. The tubular portion 52 is positioned on an opposite side to the plasma region R with respect to the main body 51. A through-hole 51a penetrating the main body 51 along the Y-axis direction is formed in the main body 51. The through-hole 51a is opened to an inside of the tubular portion 52. The intermediate portion 32 of the first electrode 3 is disposed in the through-hole 51a. The side surface of the intermediate portion 32 is airtightly joined to the inner surface of the through-hole 51a by a joining material such as a metal brazing material. The proximal end 33 of the first electrode 3 is disposed inside the tubular portion 52.

The first holder 5 is fixed to the housing 2. In the light-emitting sealed body 1A, the first holder 5 is fixed to the housing 2 via a tubular connection member 9A. The connection member 9A includes a tubular portion 91A and an inward flange 92A. The inward flange 92A is provided at an end of the tubular portion 91A on an opposite side to the housing 2. A material of the connection member 9A is, for example, a metal material such as Kovar. The inward flange 92A is airtightly joined to an outward flange 53 provided on the main body 51 of the first holder 5 by a joining material such as a metal brazing material. An end of the tubular portion 91A on the housing 2 side is airtightly joined to the housing 2 by, for example, laser welding.

A protrusion 54 extending along the Y direction is provided on an outer surface 5a of the first holder 5. The protrusion 54 protrudes toward the housing 2 along the Z-axis direction. The protrusion 54 is disposed in the groove 28A of the housing 2. A width of the protrusion 54 along a circumferential direction with the Y-axis direction as a center is slightly narrower than a width of the groove 28A along the circumferential direction.

The second electrode 4 extends from the outside of the housing 2 into the enclosed space 73 defined by the enclosure 7 via the electrode opening 27 of the housing 2 and an electrode opening 79 of the enclosure 7 to be described later. In the light-emitting sealed body 1A, the second electrode 4 is a rod-shaped member extending in the Y-axis direction. A material of the second electrode 4 is, for example, a metal material having a high melting point such as tungsten. A distal end (second distal end) 41 of the second electrode 4 faces the plasma region R in the housing 2, and faces the distal end 31 of the first electrode 3 with the plasma region R interposed therebetween. In the light-emitting sealed body 1A, the distal end 41 of the second electrode 4 faces the plasma region R in the enclosed space 73 and is enclosed by the enclosure 7.

The second holder 6 is an insulating member extending along the Y-axis direction, and holds the second electrode 4. The second holder 6 is made of an insulating material having high temperature resistance, such as ceramic. The second holder 6 includes a body 61 and a tubular portion 62. A part of the main body 61 is positioned inside the housing 2, and the rest of the main body 61 is positioned outside the housing 2. The tubular portion 62 is provided on a portion of the main body 61 positioned outside the housing 2. The tubular portion 62 is positioned on an opposite side to the plasma region R with respect to the main body 61. A through-hole 61a penetrating the main body 61 along the Y-axis direction is formed in the main body 61. The through-hole 61a is opened to an inside of the tubular portion 62. An intermediate portion 42 of the second electrode 4 is disposed in the through-hole 61a. A side surface of the intermediate portion 42 is airtightly joined to an inner surface of the through-hole 61a by a joining material such as a metal brazing material. The proximal end 43 of the second electrode 4 is disposed inside the tubular portion 62.

The second holder 6 is fixed to the housing 2. In the light-emitting sealed body 1A, the second holder 6 is fixed to the housing 2 via a tubular connection member 9B. The connection member 9B includes a tubular portion 91B and an inward flange 92B. The inward flange 92B is provided at an end of the tubular portion 91B on an opposite side to the housing 2. A material of the connection member 9B is, for example, a metal material such as Kovar. The inward flange 92B is airtightly joined to an outward flange 63 provided on the main body 61 of the second holder 6 by a joining material such as a metal brazing material. An end of the tubular portion 91B on the housing 2 side is airtightly joined to the housing 2 by, for example, laser welding.

A protrusion 64 extending along the Y direction is provided on an outer surface 6a of the second holder 6. The protrusion 64 protrudes toward the housing 2 along the Z-axis direction. The protrusion 64 is disposed in the groove 28B of the housing 2. A width of the protrusion 64 along the circumferential direction with the Y-axis direction as the center is slightly narrower than a width of the groove 28B along the circumferential direction.

The enclosure 7 is an insulating member disposed in the housing space 21 of the housing 2. A material of the enclosure 7 is an insulating material having high temperature resistance, and is, for example, ceramic. The enclosure 7 has a first enclosing portion 71 and a second enclosing portion 72. The enclosed space 73 and four light passage openings 74, 75, 76, and 77 are formed over the first enclosing portion 71 and the second enclosing portion 72. An electrode opening 78 is formed in the first enclosing portion 71. An electrode opening 79 is formed in the second enclosing portion 72. The first enclosing portion 71 and the second enclosing portion 72 abut on each other.

The enclosed space 73 includes the plasma region R. The light passage opening 74 is opened to one side in the Z-axis direction from the enclosed space 73. The light passage opening 77 is opened to the other side in the Z-axis direction from the enclosed space 73. The light passage opening 75 is opened to one side in the X-axis direction from the enclosed space 73. The light passage opening 76 is opened to the other side in the X-axis direction from the enclosed space 73. The electrode opening 78 is opened to one side in the Y-axis direction from the enclosed space 73. The electrode opening 79 is opened to the other side in the Y-axis direction from the enclosed space 73.

The light passage opening (first opening) 74 corresponds to the laser beam incidence window 10A. That is, as viewed from a direction (the Z-axis direction in the light-emitting sealed body 1A) in which the plasma region R and the laser beam incidence window 10A are arranged, the light passage opening 74 overlaps the laser beam incidence window 10A. In the light-emitting sealed body 1A, a center line of the light passage opening 74 coincides with the center line of the laser beam incidence window 10A (that is, coincides with the optical axis A1), and the light passage opening 74 is included in the laser beam incidence window 10A as viewed from the Z-axis direction. The light passage opening 74 is narrowed with respect to the enclosed space 73. That is, as viewed from a direction (the Z-axis direction in the light-emitting sealed body 1A) in which the plasma region R and the light passage opening 74 are arranged, an open end 74a of the light passage opening 74 on the enclosed space 73 side is included in the enclosed space 73. In the light-emitting sealed body 1A, the light passage opening 74 is a tapered opening in which the open end 74a on the enclosed space 73 side is smaller than an open end 74b on an opposite side to the enclosed space 73. The laser beam incidence window 10A is positioned outside the light passage opening 74.

The light passage opening (second opening) 75 corresponds to the plasma light emission window 10B. That is, as viewed from a direction (the X-axis direction in the light-emitting sealed body 1A) in which the plasma region R and the plasma light emission window 10B are arranged, the light passage opening 75 overlaps the plasma light emission window 10B. In the light-emitting sealed body 1A, a center line of the light passage opening 75 coincides with the center line of the plasma light emission window 10B (that is, coincides with the optical axis A2), and the light passage opening 75 is included in the plasma light emission window 10B as viewed from the X-axis direction. The light passage opening 75 is narrowed with respect to the enclosed space 73. That is, as viewed from a direction (the X-axis direction in the light-emitting sealed body 1A) in which the plasma region R and the light passage opening 75 are arranged, an open end 75a of the light passage opening 75 on the enclosed space 73 side is included in the enclosed space 73. In the light-emitting sealed body 1A, the light passage opening 75 is a tapered opening in which the open end 75a on the enclosed space 73 side is smaller than an open end 75b on an opposite side to the enclosed space 73. The plasma light emission window 10B is positioned outside the light passage opening 75.

The light passage opening (second opening) 76 corresponds to the plasma light emission window 10C. That is, as viewed from a direction (the X-axis direction in the light-emitting sealed body 1A) in which the plasma region R and the plasma light emission window 10C are arranged, the light passage opening 76 overlaps the plasma light emission window 10C. In the light-emitting sealed body 1A, a center line of the light passage opening 76 coincides with the center line of the plasma light emission window 10C (that is, coincides with the optical axis A2), and the light passage opening 76 is included in the plasma light emission window 10C as viewed from the X-axis direction. The light passage opening 76 is narrowed with respect to the enclosed space 73. That is, as viewed from a direction (the X-axis direction in the light-emitting sealed body 1A) in which the plasma region R and the light passage opening 76 are arranged, an open end 76a of the light passage opening 76 on the enclosed space 73 side is included in the enclosed space 73. In the light-emitting sealed body 1A, the light passage opening 76 is a tapered opening in which the open end 76a on the enclosed space 73 side is smaller than an open end 76b on an opposite side to the enclosed space 73. The plasma light emission window 10C is positioned outside the light passage opening 76.

The light passage opening 77 corresponds to the laser beam emission window 10D. That is, as viewed from a direction (the Z-axis direction in the light-emitting sealed body 1A) in which the plasma region R and the laser beam emission window 10D are arranged, the light passage opening 77 overlaps the laser beam emission window 10D. In the light-emitting sealed body 1A, a center line of the light passage opening 77 coincides with the center line of the laser beam emission window 10D (that is, coincides with the optical axis A1), and the light passage opening 77 is included in the laser beam emission window 10D as viewed from the Z-axis direction. The light passage opening 77 is narrowed with respect to the enclosed space 73. That is, as viewed from a direction (the Z-axis direction in the light-emitting sealed body 1A) in which the plasma region R and the light passage opening 77 are arranged, an open end 77a of the light passage opening 77 on the enclosed space 73 side is included in the enclosed space 73. In the light-emitting sealed body 1A, the light passage opening 77 is a tapered opening in which the open end 77a on the enclosed space 73 side is smaller than an open end 77b on an opposite side to the enclosed space 73. The laser beam emission window 10D is positioned outside the light passage opening 77.

A material of the first enclosing portion 71 and the second enclosing portion 72 is an insulating material having high temperature resistance, and is, for example, ceramic. In particular, in a case where a white ceramic is used, the amount of light extracted from the plasma light emission window 10B and the plasma light emission window 10C can be further increased by reflecting the plasma light L2. The first enclosing portion 71 has a first portion 71A and a second portion 71B. The first portion 71A defines an electrode opening 78. The first enclosing portion 71 is formed integrally with the first holder 5 in a state where the electrode opening 78 communicates with the through-hole 51a of the first holder 5. That is, the first enclosing portion 71 is provided in the first holder 5. The second enclosing portion 72 has a third portion 72A and a fourth portion 72B. The third portion 72A defines an electrode opening 79. The second enclosing portion 72 is formed integrally with the second holder 6 in a state where the electrode opening 79 communicates with the through-hole 61a of the second holder 6. That is, the second enclosing portion 72 is provided in the second holder 6.

The second portion 71B includes an inner surface 71a having a smooth concave surface shape and opened to one side in the Y-axis direction from the electrode opening 78. The fourth portion 72B includes an inner surface 72a having a smooth concave surface shape and opened to the other side in the Y-axis direction from the electrode opening 79. A curvature of each of the inner surfaces 71a and 72a changes smoothly, for example. The electrode opening 78 is opened on the inner surface 71a. The electrode opening 79 is opened on the inner surface 72a.

The second portion 71B defines a part of one side in the Y-axis direction of the light passage opening 74, and the fourth portion 72B defines the rest of the other side in the Y-axis direction of the light passage opening 74. In the light-emitting sealed body 1A, a notch corresponding to a part of the light passage opening 74 is provided in the second portion 71B, and a notch corresponding to the rest of the light passage opening 74 is provided in the fourth portion 72B. The second portion 71B defines a part of one side in the Y-axis direction of the light passage opening 75, and the fourth portion 72B defines the rest of the other side in the Y-axis direction of the light passage opening 75. In the light-emitting sealed body 1A, a notch corresponding to a part of the light passage opening 75 is provided in the second portion 71B, and a notch corresponding to the rest of the light passage opening 75 is provided in the fourth portion 72B. The second portion 71B defines a part of one side in the Y-axis direction of the light passage opening 76, and the fourth portion 72B defines the rest of the other side in the Y-axis direction of the light passage opening 76. In the light-emitting sealed body 1A, a notch corresponding to a part of the light passage opening 76 is provided in the second portion 71B, and a notch corresponding to the rest of the light passage opening 76 is provided in the fourth portion 72B. The second portion 71B defines a part of one side in the Y-axis direction of the light passage opening 77, and the fourth portion 72B defines the rest of the other side in the Y-axis direction of the light passage opening 77. In the light-emitting sealed body 1A, a notch corresponding to a part of the light passage opening 77 is provided in the second portion 71B, and a notch corresponding to the rest of the light passage opening 77 is provided in the fourth portion 72B. The four light passage openings 74, 75, 76, and 77 are opened on the inner surfaces 71a and 72a.

The enclosed space 73 is enclosed by the inner surface 71a of the second portion 71B, the inner surface 72a of the fourth portion 72B, the four light passage openings 74, 75, 76, and 77, and the two electrode openings 78 and 79 in the housing space 21. That is, the enclosure 7 defines the enclosed space 73 in the housing 2 and encloses the plasma region R in the housing 2. The distal end 31 of the first electrode 3 faces the plasma region R in the enclosed space 73 and is enclosed by the enclosure 7. The distal end 41 of the second electrode 4 faces the plasma region R in the enclosed space 73 and is enclosed by the enclosure 7.

In the main body 20 of the housing 2, in order to discharge the gas from the inside of the housing 2 and introduce the gas into the housing 2, in the present embodiment, an encapsulation hole 29 for once exhausting the inside of the housing space 21 and then encapsulating the gas G is formed. The encapsulation tube (sealing tube) 8 is connected to the encapsulation hole 29. A material of the encapsulation tube 8 is a conductive material, and is, for example, a metal material such as copper. An end of the encapsulation tube 8 on an opposite side to the encapsulation hole 29 is sealed. An outer surface of the encapsulation tube 8 is airtightly joined to an inner surface of the encapsulation hole 29 by a joining material such as a metal brazing material. In the light-emitting sealed body 1A, the encapsulation tube 8 extends along the X-axis direction.

In the light-emitting sealed body 1A having the above-described configuration, in a case where the first electrode 3 is set to a ground potential, a negative voltage pulse or a positive voltage pulse is applied to the second electrode 4. In a case where the second electrode 4 is set to the ground potential, a negative voltage pulse or a positive voltage pulse is applied to the first electrode 3. As a result, arc discharge occurs in the gas G in the enclosed space 73, and plasma is generated between the first electrode 3 and the second electrode 4. At this time, the laser beam L1 is incident on the plasma region R from the laser beam incidence window 10A, and thus, the plasma is maintained in the plasma region R. Then, the plasma light L2 emitted from the plasma is emitted as the output light to the outside from the two plasma light emission windows 10B and 10C. The laser beam L1 transmitted through the plasma region R is emitted from the laser beam emission window 10D to the outside.

As described above, in the light-emitting sealed body 1A, the plasma region R, the distal end 31 of the first electrode 3, and the distal end 41 of the second electrode 4 are enclosed by the insulating enclosure 7 in the housing 2. As a result, since a space where the gas G convects is narrowed as compared with a case where the enclosure 7 is not disposed in the housing 2, it is possible to suppress the occurrence of the convection in the gas G in the space. In addition, the first enclosing portion 71 of the enclosure 7 is provided in the first holder 5 that fixes the first electrode 3 to the housing 2. That is, since the first holder 5 that fixes the first electrode 3 to the housing 2 also serves as at least a part of the enclosure 7, at least a part of the enclosure 7 is reliably fixed to the housing 2, and vibration in the enclosure 7 can be suppressed. Further, since the space is enclosed by the insulating enclosure 7, the plasma can be stably maintained without influencing the plasma by the enclosure 7. Further, since cooling of the gas G in the enclosed space 73 by the metal housing 2 can be suppressed, the convection can be stabilized, the influence of the convection on the plasma can be suppressed, and the plasma can be stably maintained. Further, since electric connection between the first electrode 3 and the second electrode 4 via the enclosure 7 can be suppressed, the plasma can be reliably generated. Thus, in accordance with the light-emitting sealed body 1A, it is possible to improve the quality of the output light.

The light-emitting sealed body 1A includes the insulating second holder 6 that holds the second electrode 4 and is fixed to the housing 2, the enclosure 7 has the first enclosing portion 71 and the second enclosing portion 72, the first enclosing portion 71 is provided in the first holder 5, and the second enclosing portion 72 is provided in the second holder 6. As a result, the enclosure 7 having a preferable shape for suppressing the occurrence of the convection can be accurately formed, and the enclosure 7 can be stably supported by the two holders of the first holder 5 and the second holder 6. For example, since a shape of the enclosure 7 is complicated, it is difficult to integrally form the enclosure 7 with a single member, but the enclosure 7 can be accurately formed by dividing the enclosure 7 into the first enclosing portion 71 and the second enclosing portion 72.

In the light-emitting sealed body 1A, the housing 2 has the housing space 21 in which the enclosure 7 is disposed, and the electrode opening 26 opened to one side in the Y-axis direction from the housing space 21, the first holder 5 extends along the Y-axis direction inside the electrode opening 26, the groove 28A extending along the Y-axis direction is formed on the inner surface 26a of the electrode opening 26, and the protrusion 54 extending along the Y-axis direction and disposed in the groove 28A is provided on the outer surface 5a of the first holder 5. In addition, in the light-emitting sealed body 1A, the housing 2 has the electrode opening 27 opened to the other side in the Y-axis direction from the housing space 21, the second holder 6 extends along the Y-axis direction inside the electrode opening 27, the groove 28B extending along the Y-axis direction is formed on the inner surface 27a of the electrode opening 27, and the protrusion 64 extending along the Y-axis direction and disposed in the groove 28B is provided on the outer surface 6a of the second holder 6. As a result, at the time of manufacturing the light-emitting sealed body 1A, the first enclosing portion 71 and the second enclosing portion 72 of the enclosure 7 are disposed in the housing space 21 of the housing 2 via the two electrode openings 26 and 27 of the housing 2, and the first holder 5 and the second holder 6 are disposed inside the two electrode openings 26 and 27 of the housing 2 respectively. Thus, the light passage opening 74 of the enclosure 7 can correspond to the laser beam incidence window 10A of the housing 2, and the two light passage openings 75 and 76 of the enclosure 7 can correspond to the two plasma light emission windows 10B and 10C of the housing 2. In addition, in the manufactured light-emitting sealed body 1A, it is possible to reliably maintain a state where the light passage opening 74 of the enclosure 7 corresponds to the laser beam incidence window 10A of the housing 2 and the two light passage openings 75 and 76 of the enclosure 7 correspond to the two plasma light emission windows 10B and 10C of the housing 2.

In the light-emitting sealed body 1A, the enclosure 7 defines the enclosed space 73 including the plasma region R in the housing 2, the laser beam incidence window 10A is positioned on the opposite side to the enclosed space 73 with respect to the open end 74a of the light passage opening 74 on the enclosed space 73 side, the plasma light emission window 10B is positioned on the opposite side to the enclosed space 73 with respect to the open end 75a of the light passage opening 75 on the enclosed space 73 side, the plasma light emission window 10C is positioned on the opposite side to the enclosed space 73 with respect to the open end 76a of the light passage opening 76 on the enclosed space 73 side, and the three light passage openings 74, 75, and 76 are narrowed with respect to the enclosed space 73. As a result, as compared with a case where the three light passage openings 74, 75, and 76 are not narrowed with respect to the enclosed space 73, since the gas G in the enclosed space 73 is less likely to be influenced by an environment outside the housing 2, it is possible to suppress the occurrence of the convection in the gas G due to the environment outside the housing 2.

### Second Embodiment

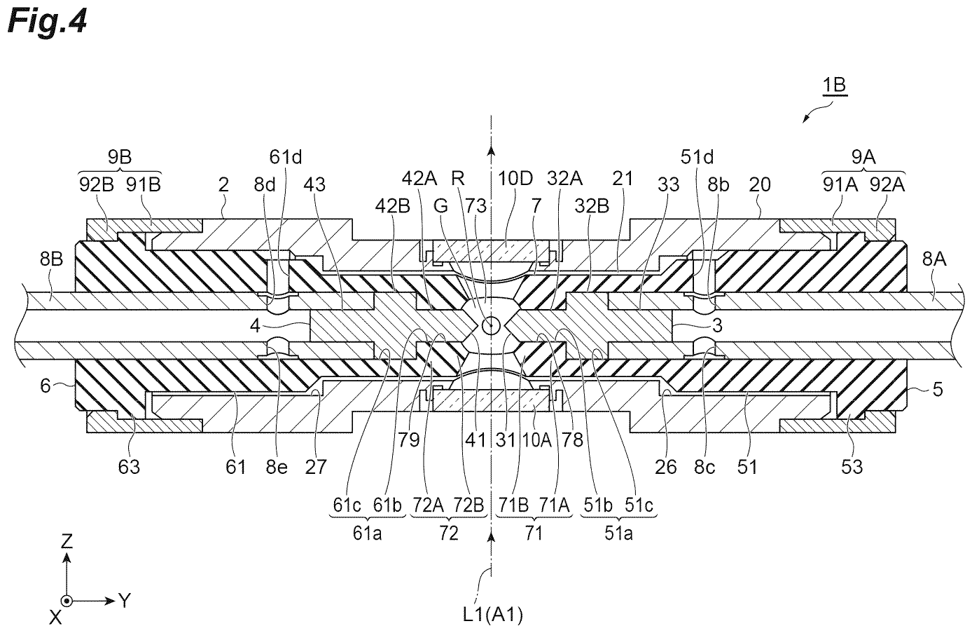

As illustrated in FIG. 4, a light-emitting sealed body 1B of a second embodiment is mainly different from the light-emitting sealed body 1A of the first embodiment in that a part of an encapsulation tube 8A is embedded in the first holder 5 and a part of an encapsulation tube 8B is embedded in the second holder 6. Hereinafter, the light-emitting sealed body 1B of the second embodiment will be described focusing on differences from the light-emitting sealed body 1A of the first embodiment.

As illustrated in FIG. 4, the first electrode 3 extends from the inside of the electrode opening 26 into the enclosed space 73 defined by the enclosure 7. The first electrode 3 has the distal end (first distal end) 31, two intermediate portions 32A and 32B, and the proximal end 33. Outer diameters of the intermediate portion 32A and the proximal end 33 are the same. An outer diameter of the intermediate portion 32B is larger than the outer diameters of the intermediate portion 32A and the proximal end 33. The second electrode 4 extends from the inside of the electrode opening 27 into the enclosed space 73 defined by the enclosure 7. The second electrode 4 has the distal end (second distal end) 41, two intermediate portions 42A and 42B, and the proximal end 43. Outer diameters of the intermediate portion 42A and the proximal end 43 are the same. An outer diameter of the intermediate portion 42B is larger than the outer diameters of the intermediate portion 42A and the proximal end 43.

The first holder 5 is an insulating member extending along the Y-axis direction, and holds the first electrode 3. A material of the first holder 5 is an insulating material having high temperature resistance, and is, for example, ceramic. The first holder 5 includes the main body 51. A part of the main body 51 is positioned inside the housing 2, and the rest of the main body 51 is positioned outside the housing 2. A through-hole 51a penetrating the main body 51 along the Y-axis direction is formed in the main body 51. The through-hole 51a includes two through-holes 51b and 51c. An inner diameter of the through-hole 51c is larger than an inner diameter of the through-hole 51b. The intermediate portion 32A of the first electrode 3 is disposed in the through-hole 51b. A side surface of the intermediate portion 32A is airtightly joined to an inner surface of the through-hole 51b by a joining material such as a metal brazing material. In the through-hole 51c, the intermediate portion 32B and the proximal end 33 of the first electrode 3 are disposed. A side surface of the intermediate portion 32B is airtightly joined to an inner surface of the through-hole 51c by a joining material such as a metal brazing material.

The light-emitting sealed body 1B includes a conductive encapsulation tube (sealing tube) 8A. A material of the encapsulation tube 8A is a conductive material, and is, for example, a metal material such as copper. The encapsulation tube 8A extends along the Y-axis direction. A pair of through-holes 8b and 8c is formed in the encapsulation tube 8A. The pair of through-holes 8b and 8c penetrates the encapsulation tube 8A along the Z-axis direction. A through-hole 51d is formed in the main body 51. The through-hole 51d penetrates the main body 51 along the Z-axis direction and is opened on the inner surface of the through-hole 51c of the main body 51. A part of the encapsulation tube 8A is disposed in the through-hole 51c of the main body 51 in a state where the through-hole 8b of the encapsulation tube 8A communicates with the through-hole 51d of the main body 51. The through-hole 51d of the main body 51 communicates with the housing space 21 of the housing 2. That is, the inside of the encapsulation tube 8A communicates with the housing space 21 of the housing 2 via the through-hole 8b of the encapsulation tube 8A and the through-hole 51d of the main body 51.

The proximal end 33 of the first electrode 3 is disposed inside the encapsulation tube 8A. An outer surface of the proximal end 33 is airtightly joined to an inner surface of the encapsulation tube 8A by a joining material such as a metal brazing material. The first electrode 3 and the encapsulation tube 8A are electrically connected to each other. An outer surface of the encapsulation tube 8A is airtightly joined to the inner surface of the through-hole 51c of the main body 51 by a joining material such as a metal brazing material. That is, a part of the first electrode 3 and a part of the encapsulation tube 8A are electrically connected to each other in a state of being embedded in the first holder 5.

The second holder 6 is an insulating member extending along the Y-axis direction, and holds the second electrode 4. A material of the second holder 6 is an insulating material having high temperature resistance, and is, for example, ceramic. The second holder 6 includes the main body 61. A part of the main body 61 is positioned inside the housing 2, and the rest of the main body 61 is positioned outside the housing 2. A through-hole 61a penetrating the main body 61 along the Y-axis direction is formed in the main body 61. The through-hole 61a includes two through-holes 61b and 61c. An inner diameter of the through-hole 61c is larger than an inner diameter of the through-hole 61b. The intermediate portion 42A of the second electrode 4 is disposed in the through-hole 61b. A side surface of the intermediate portion 42A is airtightly joined to an inner surface of the through-hole 61b by a joining material such as a metal brazing material. In the through-hole 61c, the intermediate portion 42B and the proximal end 43 of the second electrode 4 are disposed. A side surface of the intermediate portion 42B is airtightly joined to an inner surface of the through-hole 61c by a joining material such as a metal brazing material.

The light-emitting sealed body 1B includes a conductive encapsulation tube (sealing tube) 8B. A material of the encapsulation tube 8B is a conductive material, and is, for example, a metal material such as copper. The encapsulation tube 8B extends along the Y-axis direction. A pair of through-holes 8d and 8e is formed in the encapsulation tube 8B. The pair of through-holes 8d and 8e penetrates the encapsulation tube 8B along the Z-axis direction. A through-hole 61d is formed in the main body 61. The through-hole 61d penetrates the main body 61 along the Z-axis direction and is opened on the inner surface of the through-hole 61c of the main body 61. A part of the encapsulation tube 8B is disposed in the through-hole 61c of the main body 61 in a state where the through-hole 8d of the encapsulation tube 8B communicates with the through-hole 61d of the main body 61. The through-hole 61d of the main body 61 communicates with the housing space 21 of the housing 2. That is, the inside of the encapsulation tube 8B communicates with the housing space 21 of the housing 2 via the through-hole 8d of the encapsulation tube 8B and the through-hole 61d of the main body 61.

The proximal end 43 of the second electrode 4 is disposed inside the encapsulation tube 8B. An outer surface of the proximal end 43 is airtightly joined to an inner surface of the encapsulation tube 8B by a joining material such as a metal brazing material. The second electrode 4 and the encapsulation tube 8B are electrically connected to each other. An outer surface of the encapsulation tube 8B is airtightly joined to the inner surface of the through-hole 61c of the main body 61 by a joining material such as a metal brazing material. That is, a part of the second electrode 4 and a part of the encapsulation tube 8B are electrically connected to each other in a state of being embedded in the second holder 6.

The first portion 71A of the first enclosing portion 71 defines the electrode opening 78. The first enclosing portion 71 is formed integrally with the first holder 5 in a state where the electrode opening 78 communicates with the through-hole 51b of the first holder 5. That is, the first enclosing portion 71 is provided in the first holder 5. The third portion 72A of the second enclosing portion 72 defines the electrode opening 79. The second enclosing portion 72 is formed integrally with the second holder 6 in a state where the electrode opening 79 communicates with the through-hole 61b of the second holder 6. That is, the second enclosing portion 72 is provided in the second holder 6.

As described above, in order to discharge the gas from the inside of the housing 2 and introduce the gas into the housing 2, in the present embodiment, the light-emitting sealed body 1B includes the two conductive encapsulation tubes 8A and 8B for once exhausting the inside of the housing space 21 and then encapsulating the gas G, a part of the first electrode 3 and a part of the encapsulation tube 8A are electrically connected to each other in a state of being embedded in the first holder 5, and a part of the second electrode 4 and a part of the encapsulation tube 8B are electrically connected to each other in a state of being embedded in the second holder 6. As a result, not only the encapsulation tube 8A can be used for discharging the gas from the inside of the housing 2 and introducing the gas into the housing 2, but also the encapsulation tube 8A can be used for electrically connecting the first electrode 3 to an external wiring. Thus, for example, the light-emitting sealed body 1B can be made compact as compared with a case where the encapsulation tube 8A is provided in the housing 2 separately from the first holder 5. In addition, the encapsulation tube 8B can be used not only for discharging the gas from the inside of the housing 2 and introducing the gas into the housing 2, but also the encapsulation tube 8B can be used for electrically connecting the second electrode 4 to an external wiring. Thus, for example, the light-emitting sealed body 1B can be made compact as compared with a case where the encapsulation tube 8B is provided in the housing 2 separately from the second holder 6.

### Third Embodiment

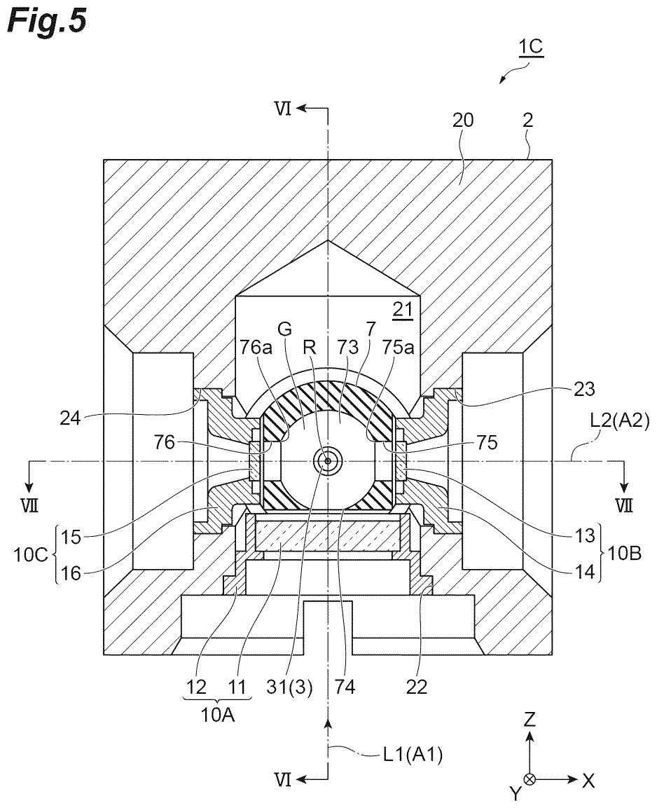

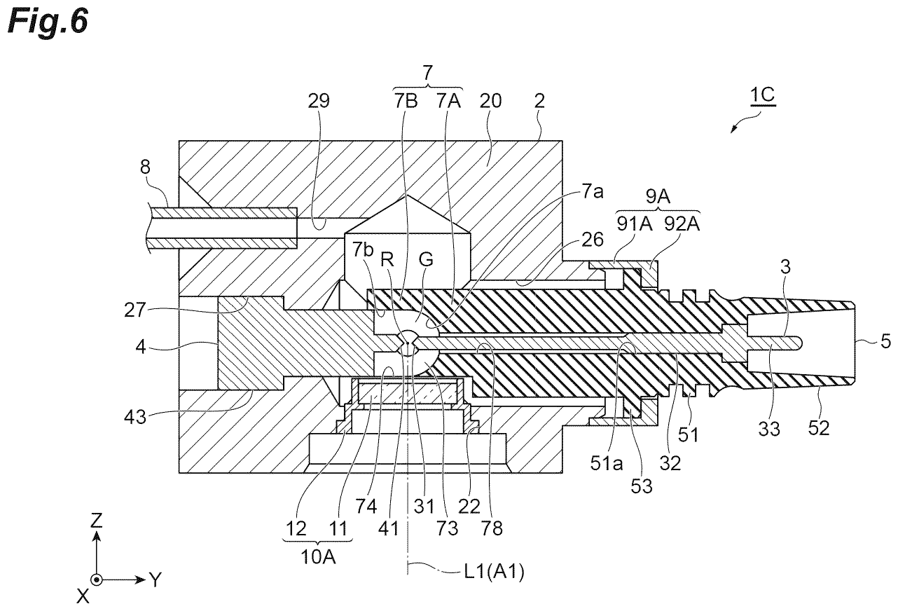

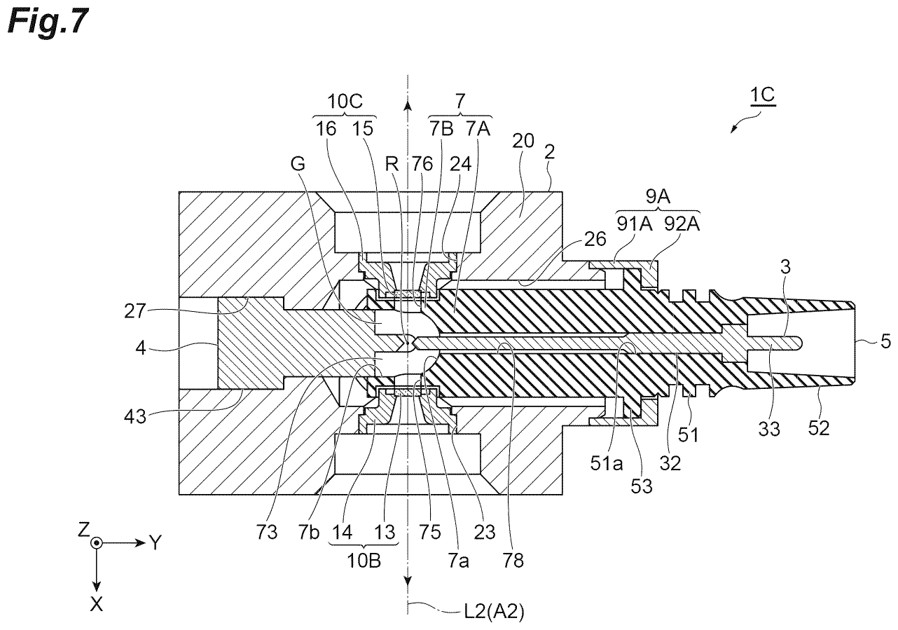

As illustrated in FIGS. 5, 6, and 7, a light-emitting sealed body 1C of a third embodiment is mainly different from the light-emitting sealed body 1A of the first embodiment in that the second electrode 4 is held by the housing 2 and the entire enclosure 7 is provided in the first holder 5. Hereinafter, the light-emitting sealed body 1C of the third embodiment will be described focusing on differences from the light-emitting sealed body 1A of the first embodiment.

The housing 2 includes the main body 20, the laser beam incidence window 10A, and two plasma light emission windows 10B and 10C. The main body 20 is a substantially rectangular parallelepiped member. In the main body 20, the housing space 21, three window openings 22, 23, and 24, and two electrode openings 26 and 27 are formed. The housing space 21 includes the plasma region R. The window opening 22 is opened to one side in the Z-axis direction from the housing space 21. The window opening 23 is opened to one side in the X-axis direction from the housing space 21. The window opening 24 is opened to the other side in the X-axis direction from the housing space 21. The electrode opening 26 is opened to one side in the Y-axis direction from the housing space 21. The electrode opening 27 is opened to the other side in the Y-axis direction from the housing space 21. A material of the main body 20 is, for example, metal such as stainless steel.

The laser beam incidence window 10A includes the window member 11 and the holding member 12. The window member 11 is formed in a plate shape with the optical axis A1 as a center line and the Z-axis direction as a thickness direction. The window member 11 transmits the laser beam L1. A material of the window member 11 is a light transmissive material having a light transmission property at least for a wavelength of the laser beam L1, and is, for example, sapphire. The holding member 12 is formed in a tubular shape with the optical axis A1 as the center line. The window member 11 is held by the holding member 12 in a state of being disposed inside the holding member 12. A material of the holding member 12 is, for example, a metal material such as Kovar. The side surface of the window member 11 is airtightly joined to an inner surface of the holding member 12 by a joining material such as a metal brazing material. An outer surface of the holding member 12 is airtightly joined to an inner surface of the window opening 22 by, for example, laser welding.

The plasma light emission window 10B has the window member 13 and the holding member 14. The window member 13 is formed in a plate shape with the optical axis A2 as a center line and the X-axis direction as a thickness direction. The window member 13 transmits the plasma light L2. A material of the window member 13 is a light transmissive material having a light transmission property at least for the wavelength of the plasma light L2, and is, for example, diamond, sapphire, or magnesium fluoride. The holding member 14 is formed in a tubular shape with the optical axis A2 as the center line. The window member 13 is held by the holding member 14 in a state of being disposed inside the holding member 14. A material of the holding member 14 is, for example, a metal material such as Kovar. The side surface of the window member 13 is airtightly joined to an inner surface of the holding member 14 by a joining material such as a metal brazing material. An outer surface of the holding member 14 is airtightly joined to an inner surface of the window opening 23 by, for example, laser welding.

The plasma light emission window 10C has the window member 15 and a holding member 16. The window member 15 is formed in a plate shape with the optical axis A2 as a center line and the X-axis direction as a thickness direction. The window member 15 transmits the plasma light L2. A material of the window member 15 is a light transmissive material having a light transmission property at least for the wavelength of the plasma light L2, and is, for example, diamond, sapphire, or magnesium fluoride. The holding member 16 is formed in a tubular shape with the optical axis A2 as the center line. The window member 15 is held by the holding member 16 in a state of being disposed inside the holding member 16. A material of the holding member 16 is, for example, a metal material such as Kovar. The side surface of the window member 15 is airtightly joined to an inner surface of the holding member 16 by a joining material such as a metal brazing material. An outer surface of the holding member 16 is airtightly joined to an inner surface of the window opening 24 by, for example, laser welding.

The first electrode 3 extends from the outside of the housing 2 into the enclosed space 73 defined by the enclosure 7 via the electrode opening 26 of the housing 2 and the electrode opening 78 of the enclosure 7. In the light-emitting sealed body 1C, the first electrode 3 is a rod-shaped member extending in the Y-axis direction. A material of the first electrode 3 is, for example, a metal material having a high melting point such as tungsten. The distal end 31 of the first electrode 3 faces the plasma region R in the housing 2. In the light-emitting sealed body 1C, the distal end 31 of the first electrode 3 faces the plasma region R in the enclosed space 73 and is enclosed by the enclosure 7.

The first holder 5 is an insulating member extending along the Y-axis direction, and holds the first electrode 3. A material of the first holder 5 is an insulating material having high temperature resistance, and is, for example, ceramic. The first holder 5 includes a main body 51 and a tubular portion 52. A part of the main body 51 is positioned inside the housing 2, and the rest of the main body 51 is positioned outside the housing 2. The tubular portion 52 is provided on a portion of the main body 51 positioned outside the housing 2. The tubular portion 52 is positioned on an opposite side to the plasma region R with respect to the main body 51. A through-hole 51a penetrating the main body 51 along the Y-axis direction is formed in the main body 51. The through-hole 51a is opened to an inside of the tubular portion 52. The intermediate portion 32 of the first electrode 3 is disposed in the through-hole 51a. The side surface of the intermediate portion 32 is airtightly joined to the inner surface of the through-hole 51a by a joining material such as a metal brazing material. The proximal end 33 of the first electrode 3 is disposed inside the tubular portion 52.

The first holder 5 is fixed to the housing 2. In the light-emitting sealed body 1C, the first holder 5 is fixed to the housing 2 via the tubular connection member 9A. The connection member 9A includes a tubular portion 91A and an inward flange 92A. The inward flange 92A is provided at an end of the tubular portion 91A on an opposite side to the housing 2. A material of the connection member 9A is, for example, a metal material such as Kovar. The inward flange 92A is airtightly joined to an outward flange 53 provided on the main body 51 of the first holder 5 by a joining material such as a metal brazing material. An end of the tubular portion 91A on the housing 2 side is airtightly joined to the housing 2 by, for example, laser welding.

The second electrode 4 extends from the inside of the electrode opening 27 of the housing 2 into the enclosed space 73 defined by the enclosure 7. In the light-emitting sealed body 1C, the second electrode 4 is a rod-shaped member extending in the Y-axis direction. A material of the second electrode 4 is, for example, a metal material having a high melting point such as tungsten. The distal end 41 of the second electrode 4 faces the plasma region R in the housing 2, and faces the distal end 31 of the first electrode 3 with the plasma region R interposed therebetween. In the light-emitting sealed body 1C, the distal end 41 of the second electrode 4 faces the plasma region R in the enclosed space 73 and is enclosed by the enclosure 7. A side surface of the proximal end 43 of the second electrode 4 is airtightly joined to the inner surface of the electrode opening 27 by a joining material such as a metal brazing material.

The enclosure 7 is an insulating member disposed in the housing space 21 of the housing 2. In the enclosure 7, the enclosed space 73, three light passage openings 74, 75, and 76, and the electrode opening 78 are formed.

The enclosed space 73 includes the plasma region R. The light passage opening 74 is opened to one side in the Z-axis direction from the enclosed space 73. The light passage opening 75 is opened to one side in the X-axis direction from the enclosed space 73. The light passage opening 76 is opened to the other side in the X-axis direction from the enclosed space 73. The electrode opening 78 is opened to one side in the Y-axis direction from the enclosed space 73.

The light passage opening 74 corresponds to the laser beam incidence window 10A. That is, as viewed from a direction (the Z-axis direction in the light-emitting sealed body 1C) in which the plasma region R and the laser beam incidence window 10A are arranged, the light passage opening 74 overlaps the laser beam incidence window 10A. In the light-emitting sealed body 1C, a center line of the light passage opening 74 coincides with the center line of the window member 11 of the laser beam incidence window 10A (that is, coincides with the optical axis A1), and the light passage opening 74 is included in the window member 11 of the laser beam incidence window 10A as viewed from the Z-axis direction. The light passage opening 74 is narrowed with respect to the enclosed space 73. That is, as viewed from a direction (the Z-axis direction in the light-emitting sealed body 1C) in which the plasma region R and the light passage opening 74 are arranged, the light passage opening 74 is included in the enclosed space 73. The laser beam incidence window 10A is positioned outside the light passage opening 74.

The light passage opening 75 corresponds to the plasma light emission window 10B. That is, as viewed from a direction (the X-axis direction in the light-emitting sealed body 1C) in which the plasma region R and the plasma light emission window 10B are arranged, the light passage opening 75 overlaps the plasma light emission window 10B. In the light-emitting sealed body 1C, a center line of the light passage opening 75 coincides with the center line of the plasma light emission window 10B (that is, coincides with the optical axis A2), and the light passage opening 75 is included in the plasma light emission window 10B as viewed from the X-axis direction. The light passage opening 75 is narrowed with respect to the enclosed space 73. That is, as viewed from a direction (the X-axis direction in the light-emitting sealed body 1C) in which the plasma region R and the light passage opening 75 are arranged, an open end 75a of the light passage opening 75 on the enclosed space 73 side is included in the enclosed space 73. In the light-emitting sealed body 1C, a space inside the light passage opening 75 has a cylindrical shape. The plasma light emission window 10B is positioned outside the light passage opening 75.

The light passage opening 76 corresponds to the plasma light emission window 10C. That is, as viewed from a direction (the X-axis direction in the light-emitting sealed body 1C) in which the plasma region R and the plasma light emission window 10C are arranged, the light passage opening 76 overlaps the plasma light emission window 10C. In the light-emitting sealed body 1C, a center line of the light passage opening 76 coincides with the center line of the plasma light emission window 10C (that is, coincides with the optical axis A2), and the light passage opening 76 is included in the plasma light emission window 10C as viewed from the X-axis direction. The light passage opening 76 is narrowed with respect to the enclosed space 73. That is, as viewed from a direction (the X-axis direction in the light-emitting sealed body 1C) in which the plasma region R and the light passage opening 76 are arranged, an open end 76a of the light passage opening 76 on the enclosed space 73 side is included in the enclosed space 73. In the light-emitting sealed body 1C, a space inside the light passage opening 76 has a cylindrical shape. The plasma light emission window 10C is positioned outside the light passage opening 76.

A material of the enclosure 7 is an insulating material having high temperature resistance, and is, for example, ceramic. In particular, in a case where a white ceramic is used, the amount of light extracted from the plasma light emission window 10B and the plasma light emission window 10C can be further increased by reflecting the plasma light L2. The enclosure 7 includes a first portion 7A and a second portion 7B which are integrally formed. The first portion 7A defines the electrode opening 78. The enclosure 7 is formed integrally with the first holder 5 in a state where the electrode opening 78 communicates with the through-hole 51a of the first holder 5. That is, the entire enclosure 7 is provided in the first holder 5.

The second portion 7B includes an inner surface 7a having a smooth concave surface shape and an inner surface 7b opened to one side in the Y-axis direction from the electrode opening 78. A space surrounded by the inner surface 7b has a cylindrical shape. A curvature of the inner surface 7a is constant, for example. In the light-emitting sealed body 1C, the inner surface 7a has a hemispherical shape. The electrode opening 78 is opened on the inner surface 7a. The three light passage openings 74, 75, and 76 are opened on the inner surfaces 7a and 7b. The second electrode 4 abuts on the inner surface 7b.

The enclosed space 73 is enclosed by the inner surfaces 7a and 7b of the second portion 7B, the three light passage openings 74, 75, and 76, and the electrode opening 78 in the housing space 21. That is, the enclosure 7 defines the enclosed space 73 in the housing 2 and encloses the plasma region R in the housing 2. The distal end 31 of the first electrode 3 faces the plasma region R in the enclosed space 73 and is enclosed by the enclosure 7. The distal end 41 of the second electrode 4 faces the plasma region R in the enclosed space 73 and is enclosed by the enclosure 7.

In the main body 20 of the housing 2, in order to discharge the gas from the inside of the housing 2 and introduce the gas into the housing 2, in the present embodiment, an encapsulation hole 29 for once exhausting the inside of the housing space 21 and then encapsulating the gas G is formed. The encapsulation tube 8 is connected to the encapsulation hole 29. A material of the encapsulation tube 8 is a conductive material, and is, for example, a metal material such as copper. An end of the encapsulation tube 8 on an opposite side to the encapsulation hole 29 is sealed. An outer surface of the encapsulation tube 8 is airtightly joined to an inner surface of the encapsulation hole 29 by a joining material such as a metal brazing material. In the light-emitting sealed body 1C, the encapsulation tube 8 extends along the Y-axis direction.

As described above, in the light-emitting sealed body 1C, the entire enclosure 7 is provided in the first holder 5. Thus, the enclosure 7 can be stably supported with a simple structure.

### Fourth Embodiment

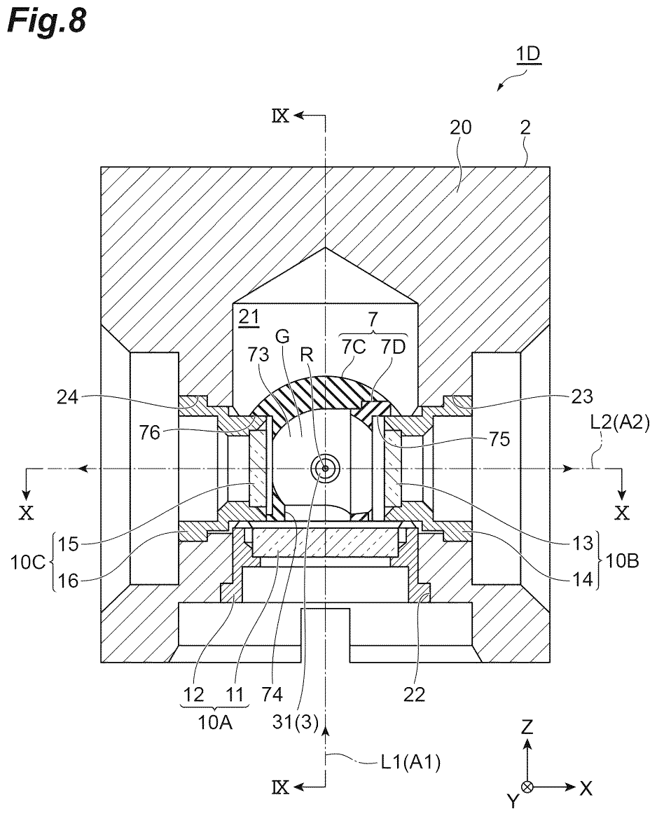

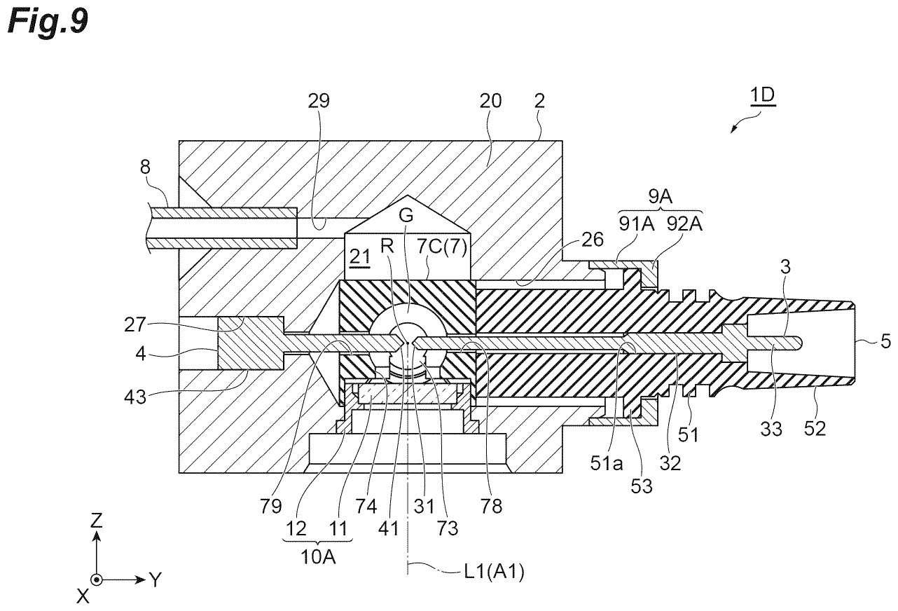

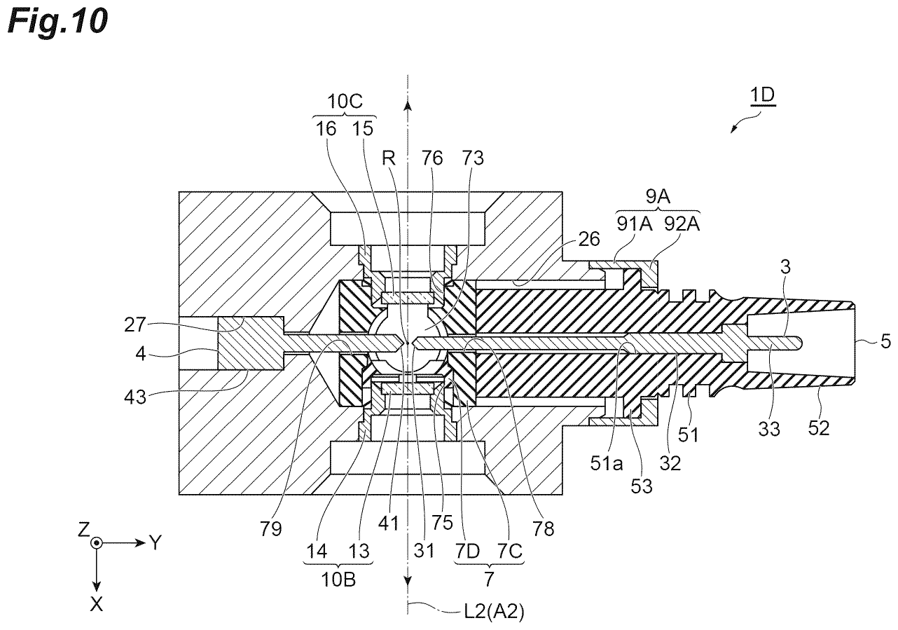

As illustrated in FIGS. 8, 9, and 10, a light-emitting sealed body 1D of a fourth embodiment is mainly different from the light-emitting sealed body 1C of the third embodiment in that the enclosure 7 has a first enclosing member 7C and a second enclosing member 7D, a part of the plasma light emission window 10B is positioned inside the light passage opening 75, and a part of the plasma light emission window 10C is positioned inside the light passage opening 76. Hereinafter, the light-emitting sealed body 1D of the third embodiment will be described focusing on differences from the light-emitting sealed body 1C of the third embodiment.

As illustrated in FIGS. 8, 9, and 10, the enclosed space 73, three light passage openings 74, 75, and 76, and two electrode openings 78 and 79 are formed in the enclosure 7. A material of the enclosure 7 is an insulating material having high temperature resistance, and is, for example, ceramic. In particular, in a case where a white ceramic is used, the amount of light extracted from the plasma light emission window 10B and the plasma light emission window 10C can be further increased by reflecting the plasma light L2. The enclosure 7 includes the first enclosing member 7C and the second enclosing member 7D. The first enclosing member 7C defines most of the enclosed space 73, the two light passage openings 74 and 76, and the two electrode openings 78 and 79. The second enclosing member 7D defines the light passage opening 75 and a part of the enclosed space 73 on the light passage opening 75 side. The first enclosing member 7C is formed integrally with the first holder 5 in a state where the electrode opening 78 communicates with the through-hole 51a of the first holder 5. That is, the first enclosing member 7C is provided in the first holder 5. A part of the plasma light emission window 10B is positioned inside the light passage opening 75. A part of the plasma light emission window 10C is positioned inside the light passage opening 76.

As described above, in the light-emitting sealed body 1D, a part of the plasma light emission window 10B is positioned inside the light passage opening 75, and a part of the plasma light emission window 10C is positioned inside the light passage opening 76. As a result, it is possible to more reliably suppress the occurrence of the convection in the gas G.

### Fifth Embodiment

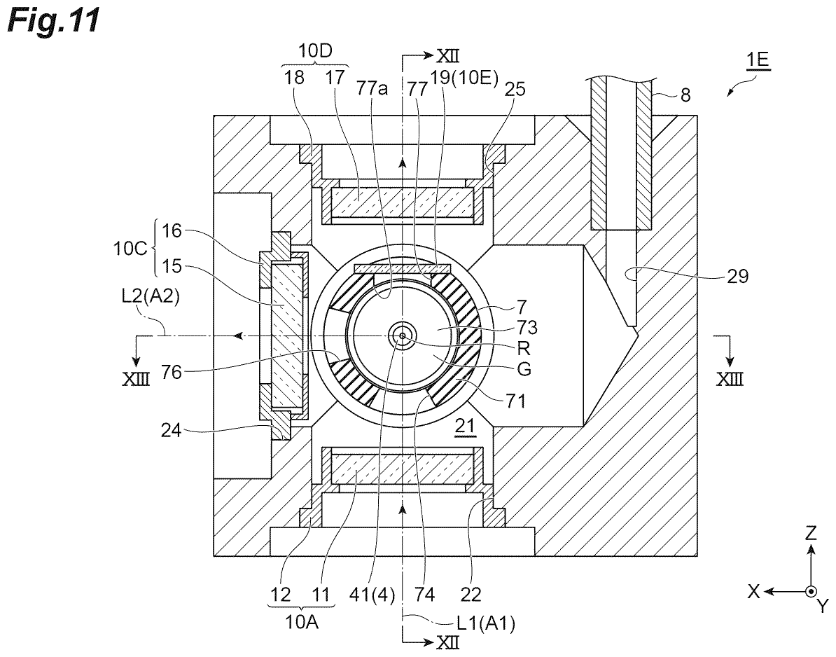

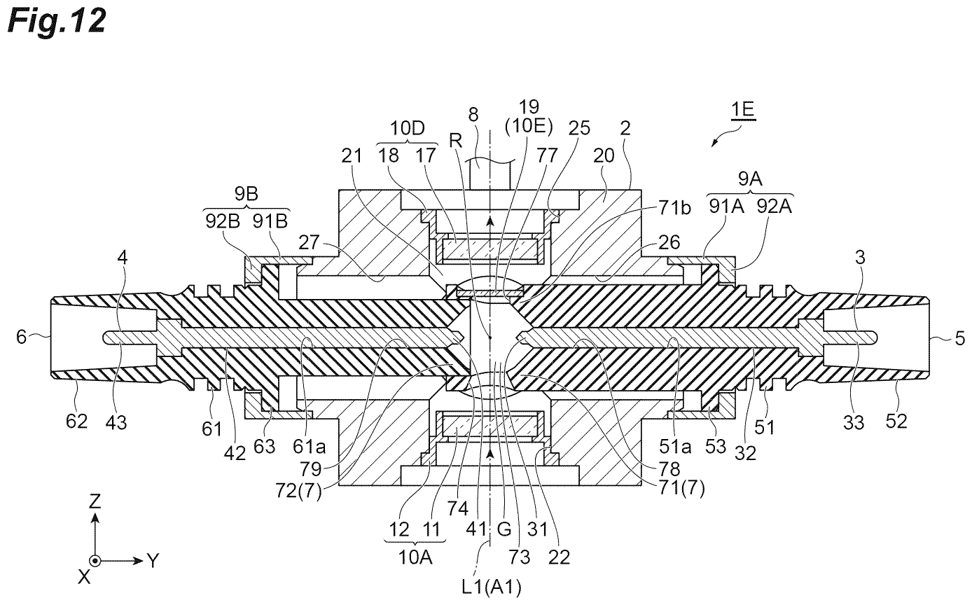

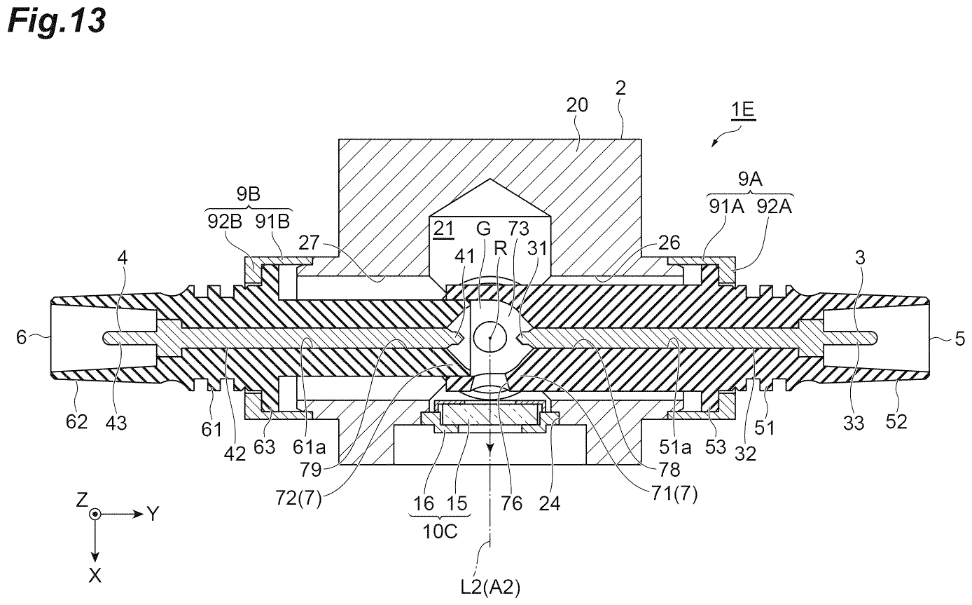

As illustrated in FIGS. 11, 12, and 13, a light-emitting sealed body 1E of a fifth embodiment is mainly different from the light-emitting sealed body 1C of the third embodiment in that the housing 2 has the laser beam emission window 10D, the second electrode 4 is held by the second holder 6, the first enclosing portion 71 of the enclosure 7 is provided in the first holder 5, and the second enclosing portion 72 of the enclosure 7 is provided in the second holder 6, and the enclosure 7 has a laser beam passage window 10E. Hereinafter, the light-emitting sealed body 1E of the fifth embodiment will be described focusing on differences from the light-emitting sealed body 1C of the third embodiment.

The housing 2 includes the main body 20, the laser beam incidence window 10A, the plasma light emission window 10C, and the laser beam emission window 10D. The main body 20 is a substantially rectangular parallelepiped member. In the main body 20, the housing space 21, three window openings 22, 24, and 25, and two electrode openings 26 and 27 are formed. The housing space 21 includes the plasma region R. The window opening 22 is opened to one side in the Z-axis direction from the housing space 21. The window opening 25 is opened to the other side in the Z-axis direction from the housing space 21. The window opening 24 is opened to one side in the X-axis direction from the housing space 21. The electrode opening 26 is opened to one side in the Y-axis direction from the housing space 21. The electrode opening 27 is opened to the other side in the Y-axis direction from the housing space 21. A material of the main body 20 is, for example, metal such as stainless steel.

The laser beam emission window 10D includes the window member 17 and a holding member 18. The window member 17 is formed in a plate shape with the optical axis A1 as a center line and the Z-axis direction as a thickness direction. The window member 17 transmits the laser beam L1. A material of the window member 17 is a light transmissive material having a light transmission property at least for the wavelength of the laser beam L1, and more preferably a light transmissive material having a light transmission property for the wavelength of the plasma light L2 in addition to the wavelength of the laser beam L1. In the present embodiment, a material of the window member 17 is a material having a light transmission property for the wavelengths of both the laser beam L1 and the plasma light L2, and is, for example, sapphire. The holding member 18 is formed in a tubular shape with the optical axis A1 as a center line. The window member 17 is held by the holding member 18 in a state of being disposed inside the holding member 18. A material of the holding member 18 is, for example, a metal material such as Kovar. The side surface of the window member 17 is airtightly joined to an inner surface of the holding member 18 by a joining material such as a metal brazing material. An outer surface of the holding member 18 is airtightly joined to an inner surface of the window opening 25 by, for example, laser welding.

The second electrode 4 extends from the outside of the housing 2 into the enclosed space 73 defined by the enclosure 7 via the electrode opening 27 of the housing 2 and the electrode opening 79 of the enclosure 7. In the light-emitting sealed body 1E, the second electrode 4 is a rod-shaped member extending in the Y-axis direction. A material of the second electrode 4 is, for example, a metal material having a high melting point such as tungsten. The distal end 41 of the second electrode 4 faces the plasma region R in the housing 2. In the light-emitting sealed body 1E, the distal end 41 of the second electrode 4 faces the plasma region R in the enclosed space 73 and is enclosed by the enclosure 7.

The second holder 6 is an insulating member extending along the Y-axis direction, and holds the second electrode 4. A material of the second holder 6 is an insulating material having high temperature resistance, and is, for example, ceramic. The second holder 6 includes a main body 61 and a tubular portion 62. A part of the main body 61 is positioned inside the housing 2, and the rest of the main body 61 is positioned outside the housing 2. The tubular portion 62 is provided on a portion of the main body 61 positioned outside the housing 2. The tubular portion 62 is positioned on an opposite side to the plasma region R with respect to the main body 61. A through-hole 61a penetrating the main body 61 along the Y-axis direction is formed in the main body 61. The through-hole 61a is opened to an inside of the tubular portion 62. An intermediate portion 42 of the second electrode 4 is disposed in the through-hole 61a. A side surface of the intermediate portion 42 is airtightly joined to an inner surface of the through-hole 61a by a joining material such as a metal brazing material. The proximal end 43 of the second electrode 4 is disposed inside the tubular portion 62.

The second holder 6 is fixed to the housing 2. In the light-emitting sealed body 1E, the second holder 6 is fixed to the housing 2 via the tubular connection member 9B. The connection member 9B includes a tubular portion 91B and an inward flange 92B. The inward flange 92B is provided at an end of the tubular portion 91B on an opposite side to the housing 2. A material of the connection member 9B is, for example, a metal material such as Kovar. The inward flange 92B is airtightly joined to an outward flange 63 provided on the main body 61 of the second holder 6 by a joining material such as a metal brazing material. An end of the tubular portion 91B on the housing 2 side is airtightly joined to the housing 2 by, for example, laser welding.

In the enclosure 7, the enclosed space 73, three light passage openings 74, 76, and 77, and two electrode openings 78 and 79 are formed. The enclosed space 73 includes the plasma region R. The light passage opening 74 is opened to one side in the Z-axis direction from the enclosed space 73. The light passage opening 77 is opened to the other side in the Z-axis direction from the enclosed space 73. The light passage opening 76 is opened to one side in the X-axis direction from the enclosed space 73. The electrode opening 78 is opened to one side in the Y-axis direction from the enclosed space 73. The electrode opening 79 is opened to the other side in the Y-axis direction from the enclosed space 73.

The light passage opening 77 corresponds to the laser beam emission window 10D. That is, as viewed from a direction (the Z-axis direction in the light-emitting sealed body 1E) in which the plasma region R and the laser beam emission window 10D are arranged, the light passage opening 77 overlaps the laser beam emission window 10D. In the light-emitting sealed body 1E, a center line of the light passage opening 77 coincides with the center line of the laser beam emission window 10D (that is, coincides with the optical axis A1), and the light passage opening 77 is included in the laser beam emission window 10D as viewed from the Z-axis direction. The light passage opening 77 is narrowed with respect to the enclosed space 73. That is, as viewed from a direction (the Z-axis direction in the light-emitting sealed body 1E) in which the plasma region R and the light passage opening 77 are arranged, an open end 77a of the light passage opening 77 on the enclosed space 73 side is included in the enclosed space 73. The laser beam emission window 10D is positioned outside the light passage opening 77.

The enclosure 7 has the laser beam passage window 10E. The laser beam passage window 10E is disposed in the light passage opening 77. The laser beam passage window 10E faces the laser beam emission window 10D and faces the laser beam incidence window 10A with the plasma region R interposed therebetween. The laser beam passage window 10E emits the laser beam L1 transmitted through the plasma from the plasma region R. In the present embodiment, in addition to the laser beam L1 transmitted through the plasma, the plasma light L2 emitted from the plasma region R to the laser beam passage window 10E side is also emitted, but is not illustrated for simplification of the drawing. Note that, an optical axis of the plasma light L2 emitted from the laser beam passage window 10E is coaxial with the laser beam L1. In the light-emitting sealed body 1E, the laser beam passage window 10E emits the laser beam L1 from the plasma region R along the optical axis A1. In other words, the emitted light emitted from the laser beam passage window 10E has an optical axis coaxial with the optical axis A1 of the laser beam L1. The laser beam passage window 10E has an insulating window member 19. The window member 19 is formed in a plate shape with the optical axis A1 as a center line and the Z-axis direction as a thickness direction. The window member 19 transmits the laser beam L1. A material of the window member 19 is a light transmissive material having a light transmission property at least for the wavelength of the laser beam L1, and more preferably a light transmissive material having a light transmission property for the wavelength of the plasma light L2 in addition to the wavelength of the laser beam L1. In the present embodiment, the material of the window member 19 is a material having a light transmission property for the wavelengths of both the laser beam L1 and the plasma light L2, and is, for example, sapphire. A light passage region of the laser beam passage window 10E (a region through which the laser beam L1 passes) is defined by a wall 71b of the first enclosing portion 71 having a light shielding property. In the light-emitting sealed body 1E, a light passage region of the window member 19 is defined by the wall 71b. In other words, as viewed from the direction (the Z-axis direction in the light-emitting sealed body 1E) in which the plasma region R and the light passage opening 77 are arranged, the light passage region of the window member 19 is enclosed by the wall 71b.

The enclosure 7 has a first enclosing portion 71 and a second enclosing portion 72. The first enclosing portion 71 defines most of the enclosed space 73, the three light passage openings 74, 76, and 77, and the electrode opening 78. The second enclosing portion 72 defines the electrode opening 79 and a part of the enclosed space 73 on the electrode opening 79 side. The first enclosing portion 71 is formed integrally with the first holder 5 in a state where the electrode opening 78 communicates with the through-hole 51a of the first holder 5. That is, the first enclosing portion 71 is provided in the first holder 5. The first enclosing portion 71 is formed integrally with the second holder 6 in a state where the electrode opening 79 communicates with the through-hole 61a of the second holder 6. That is, the second enclosing portion 72 is provided in the second holder 6.

As described above, in the light-emitting sealed body 1E, the enclosure 7 includes the laser beam passage window 10E that emits the laser beam L1 transmitted through the plasma from the plasma region R. Accordingly, even though the space where the gas G convects is narrowed such that the convection in the gas G is less likely to occur, of the laser beam L1 incident on the space, the laser beam L1 transmitted through the plasma is transmitted through the laser beam passage window 10E. Thus, the enclosure 7 is less likely to be damaged by irradiation with the laser beam L1 transmitted through the plasma. Thus, in accordance with the light-emitting sealed body 1E, it is possible to achieve both the improvement in the quality of the output light and the improvement in the life of the device.

### Modifications

The present disclosure is not limited to the above embodiments. For example, in the light-emitting sealed body 1A of the first embodiment, the groove 28A extending along the Y-axis direction is formed on the inner surface 26a of the electrode opening 26, and the protrusion 54 extending along the Y-axis direction and disposed in the groove 28A is provided on the outer surface 5a of the first holder 5. However, a groove extending along the Y-axis direction may be formed on the outer surface 5a of the first holder 5, and a protrusion extending along the Y-axis direction and disposed in the groove may be provided on the inner surface 26a of the electrode opening 26. Similarly, a groove extending along the Y-axis direction may be formed on the outer surface 6a of the second holder 6, and a protrusion extending along the Y-axis direction and disposed in the groove may be provided on the inner surface 27a of the electrode opening 27.

In the light-emitting sealed body 1A of the first exemplary embodiment, the first enclosing portion 71 and the second enclosing portion 72 abut on each other, but a gap may be provided between the first enclosing portion 71 and the second enclosing portion 72 to such an extent that the gap does not serve as a path for the convection in the gas G in the enclosed space 73. In the light-emitting sealed body 1C of the third embodiment, the inner surface 7b of the second portion 7B of the enclosure 7 abuts on the second electrode 4. However, a gap may be provided between the inner surface 7b and the second electrode 4 to such an extent that the gap does not serve as the path of the convection in the gas G in the enclosed space 73.

In the light-emitting sealed body 1A of the first embodiment and the light-emitting sealed body 1C of the second embodiment, one opening of the three light passage openings 74, 75, and 76 may be narrowed with respect to the enclosed space 73. In this case, the occurrence of the convection in the gas G can also be reliably suppressed.

In the light-emitting sealed body 1A of the first exemplary embodiment, the encapsulation tube 8 discharges the gas from the inside of housing 2 and introduces the gas into the housing 2, but the encapsulation tube 8 may perform at least one of the discharge of the gas from the inside of housing 2 and the introduction of the gas into housing 2. In the light-emitting sealed body 1B of the second embodiment, each of the two encapsulation tubes 8A and 8B discharges the gas from the inside of the housing 2 and introduces the gas into the housing 2, but each of the two encapsulation tubes 8A and 8B may perform at least one of the discharge of the gas from the inside of the housing 2 and the introduction of the gas into the housing 2.

### REFERENCE SIGNS LIST

1A, 1B, 1C, 1D, 1E light-emitting sealed body
2 housing
3 first electrode
4 second electrode
5 first holder
5a, 6a outer surface
6 second holder
7 enclosure
26a, 27a inner surface
8, 8A, 8B encapsulation tube
10A laser beam incidence window (first window)
10B, 10C plasma light emission window (second window)
21 housing space
22a, 22b, 23a, 23b, 24a, 24b, 25a, 25b opening
74a, 75a, 76a, 77a open end
26, 27 electrode opening (third opening)
28A, 28B groove
31 distal end (first distal end)
41 distal end (second distal end)
54, 64 protrusion
71 first enclosing portion
72 second enclosing portion
73 enclosed space
74 light passage opening (first opening)
75, 76 light passage opening (second opening)
G gas
L1 laser beam (first light)
L2 plasma light (second light)
R plasma region.

1. A light-emitting sealed body comprising:
a housing that houses a gas for generating plasma, the housing including a first window configured to cause first light for maintaining the plasma in a plasma region where the plasma is generated to be incident on the plasma region and a second window configured to emit second light emitted from the plasma from the plasma region;
a first electrode having a first distal end facing the plasma region in the housing;
a second electrode having a second distal end facing the plasma region in the housing, the second distal end facing the first distal end with the plasma region interposed therebetween;
an insulating first holder holding the first electrode and fixed to the housing; and
an insulating enclosure enclosing the plasma region, the first distal end, and the second distal end in the housing and having a first opening corresponding to the first window and a second opening corresponding to the second window,
wherein at least a part of the enclosure is provided to the first holder.

2. The light-emitting sealed body according to claim 1, further comprising:
an insulating second holder holding the second electrode and fixed to the housing,
wherein the enclosure has a first enclosing portion and a second enclosing portion,
the first enclosing portion is provided as the part to the first holder, and
the second enclosing portion is provided to the second holder.

3. The light-emitting sealed body according to claim 1, wherein the entire enclosure is provided to the first holder.

4. The light-emitting sealed body according to claim 1,
wherein the housing has a housing space in which the enclosure is disposed, and a third opening opened to one side in a predetermined direction from the housing space,
the first holder extends along the predetermined direction inside the third opening,
a groove extending along the predetermined direction is formed on one of an inner surface of the third opening and an outer surface of the first holder, and
a protrusion extending along the predetermined direction and disposed in the groove is provided to the other of the inner surface of the third opening and the outer surface of the first holder.

5. The light-emitting sealed body according to claim 1, further comprising:
a conductive sealing tube configured to perform at least one of discharge of the gas from the housing and introduction of the gas into the housing,
wherein a part of the first electrode and a part of the sealing tube are electrically connected to each other in a state of being embedded in the first holder.

6. The light-emitting sealed body according to claim 1,
wherein the enclosure defines an enclosed space including the plasma region in the housing,
the first window is positioned on an opposite side to the enclosed space with respect to an open end of the first opening on the enclosed space side,
the second window is positioned on an opposite side to the enclosed space with respect to an open end of the second opening on the enclosed space side, and
at least one of the first opening and the second opening is narrowed with respect to the enclosed space.
